(19) United States
(12) Patent Application Publication
(10) Pub. No.: US 2020/0209095 A1
(43) Pub. Date: Jul. 2, 2020

(54) LEAK DETECTION AND LOCATING SYSTEM AND METHOD

(71) Applicant: Shai Shalom SWISSA, Beer Sheva (IL)

(72) Inventor: Shai Shalom SWISSA, Beer Sheva (IL)

(21) Appl. No.: 16/632,816

(22) PCT Filed: Jul. 24, 2018
(86) PCT No.: PCT/IL2018/050823

§ 371 Date: Jan. 21, 2020

(30) Foreign Application Priority Data
Jul. 24, 2017 (IL) 253638

(51) Int. Cl. G01M 3/18; G01N 27/04; G06K 9/00

(52) U.S. Cl. CPC G01M 3/182; G06K 9/00671; G01N 27/048

(57) ABSTRACT

Leaks detection and locating system, comprising: a) an Augmented Reality (AR) scanning means for providing data suitable for deploying virtual image over the location of real-world objects of mapped infrastructure installation in an installation site; b) at least one moisture sensor adapted to be installed in conjunction with at least one pipe as part of said infrastructure installation, wherein said at least one sensor configured to generate an electrical leak alert signal upon detecting moisture above a predefined threshold; and c) a control unit configured to receive leak alert signals from said at least one moisture sensor, to process said received signals in order to determine a leakage location at said infrastructure, and to enable visual indication of the leakage location by superimposition of virtual images of at least part of said mapped infrastructure installation over the location of real-world objects.

### FIELD OF THE INVENTION

The present invention relates to the field of leakage detection systems. More particularly, the invention relates to a system for determining if and where a leak has occurred in a pipe line.

### BACKGROUND OF THE INVENTION

Pipe lines are important components in a building (e.g. a house) and have high potential for failures (e.g. leaks). A faulty pipe or pipes may cause severe harm to a structure due to ongoing moisturizing of areas of the structure (e.g. infrastructure, walls or any other part of the structure that isn't designed to withstand moisture). Moreover, ongoing leaks may cause liquid accumulations of stagnant water (or other liquids) that may eventually become a health hazard.

Late Detection of a leak in a pipe may require serious, time and cost demanding treatment of the moist infected area, besides the waist of water caused. Early detection however may seriously reduce the damage and the extent of the infection caused by the leak.

Pipes are typically distributed throughout walls, under floors and in ceilings of structures. This feature obviously makes the detection of leaks in such pipes very difficult. Moreover, the detection of a small unknown leak is virtually impossible in such hidden pipes.

Several commercial solutions are presently available for detecting and locating leaks in liquid pipes. For example, in acoustic emitting detection systems sensors are provided at several locations along a pipe's exterior in order to detect noise caused by a leak. Such a detection system would overlook quiet leaks (i.e. leaks that barely cause noise, such as a trickling pipe).

Another exemplary commercially available leak detection system is a digital leak cable in which a leak is detected according to changes in an electrical signal transmitted through electrical components within the cable, the changes caused by liquid coming in contact with the electrical components and modifying electrical properties thereof.

However, none of the prior-arts provide a solution in assisting the locating and mapping of a leak to a specific location within a building.

It is therefore an object of the present invention to provide a system for detecting and locating leaks in pipes that overcomes the drawbacks of the prior art.

Other objects and advantages of this invention will become apparent as the description proceeds.

### SUMMARY OF THE INVENTION

Leaks detection and locating system, comprising:
a) an Augmented Reality (AR) scanning means for providing data suitable for deploying virtual image over the location of real-world objects of mapped infrastructure installation in an installation site;
b) at least one moisture sensor adapted to be installed in conjunction with at least one pipe as part of said infrastructure installation, wherein said at least one sensor configured to generate an electrical leak alert signal upon detecting moisture above a predefined threshold; and
c) a control unit configured to receive leak alert signals from said at least one moisture sensor, to process said received signals in order to determine a leakage location at said infrastructure, and to enable visual indication of the leakage location by superimposition of virtual images of at least part of said mapped infrastructure installation over the location of real-world objects.

According to an embodiment of the invention, the control unit is configured to determine whether a received leak alert signal is a true or false alarm.

According to an embodiment of the invention, the moisture sensor is a sensing cable adapted to be installed adjacent and along the at least one pipe.

According to an embodiment of the invention, the sensing cable comprises at least two metal sensing wires, a continuity wire and a signal wire, protected by a fiber material, thus an electrical leak alert signal is generated by said sensing cable when water is soaked through said fiber material and connects said two metal sensing wires together, creating a short circuit between said two sensing wires, wherein the short circuit location defines the leakage location.

According to an embodiment of the invention, the control unit determines the leakage location by calculating the distance of the short circuit location from a predetermined reference point.

According to an embodiment of the invention, the reference point is located at one end of the sensing cable through which the electrical leak alert signal is provided to the control unit.

According to an embodiment of the invention, the scanning means comprises a three-dimensional (3D) AR scanner.

According to an embodiment of the invention, the visual indication of the leakage location is provided via a mobile device suitable to render virtual images over the location of real-world objects. For example, the mobile device can be a smartphone, a tablet, smart glasses, an Augmented Reality (AR) Head-Up-Display (HUD), etc.

In another aspect, the present invention relates to a method for detecting leaks in a pipe, comprising:
a. Providing, by an Augmented Reality (AR) scanning means, data suitable for deploying virtual image over the location of real-world objects of mapped infrastructure installation in an installation site, wherein the infrastructure installation comprises at least one pipe and at least one corresponding moisture sensor adapted to be installed in conjunction with said at least one pipe, wherein said at least one moisture sensor is configured to generate an electrical leak alert signal upon detecting moisture above a predefined threshold;
b. Upon receiving, by a control unit, an electrical leak alert signal generated by a moisture sensor, processing said received alert signal, determining whether said received alert signal is a true or false alarm and obtaining a leakage location at said infrastructure in accordance with the origin from which the electrical leak alert signal has been generated; and
c. For a true alarm, generating a leakage notification that enables the visual indication of the leakage location by superimposition of virtual images of at least part of said mapped infrastructure installation over the location of real-world objects.

According to an embodiment of the invention, the infrastructure installation is being scanned at the installation site before being concealed by one or more covering layers, thereby enabling to provide visual indication of the mapped infrastructure installation by superimposition of virtual images of said mapped infrastructure installation or at least part of said mapped infrastructure installation over the location of real-world objects that conceals said infrastructure, such as the one or more covering layers.

According to an embodiment of the invention, the visual indication comprises combination of images of the mapped infrastructure installation and data relative to the leakage location.

According to an embodiment of the invention, the visual indication further comprises one or more real-world objects that at least partially cover the mapped infrastructure.

According to an embodiment of the invention, the moister sensor is a sensing cable that comprises at least two metal sensing wires, a continuity wire and a signal wire, protected by a fiber material, thus an electrical leak alert signal is generated by said sensing cable when water is soaked through said fiber material and connects said two metal sensing wires together, creating a short circuit between said two sensing wires, wherein the short circuit location defines the leakage location.

According to an embodiment of the invention, the leakage location is obtained by calculating the distance of the short circuit location from a predetermined reference point.

In yet another aspect the present invention relates to a system for detecting leaks in a pipe, comprising:
a. one or more moisture sensors adapted to be situated adjacent to said pipe, wherein said one or more moisture sensors configured to generate an electrical leak alert signal upon detecting moisture above a predefined threshold;
b. a processing unit configured to receive leak alert signals from said one or more moisture sensors and issue electrical leak notifications regarding a received signal to relevant parties, said notifications indicating that a leak has been detected by a moisture sensor; and
c. a data communication channel between said one or more moisture sensors and said processing unit for transferring data therebetween.

According to an embodiment of the invention, the system further comprises a distribution element among which moisture sensors are distributed, wherein the distribution element is situated in adjacency to a pipe such that each sensor is capable of detecting moisture in the pipe's exterior.

According to an embodiment of the invention, the distribution element is in the form of elongated strips of a predefined length.

According to an embodiment of the invention, each strip can be placed adjacent to a pipe or to any other location where leak detection is required and uniquely connected on either side to a predefined other strip by a unique connector, thereby facilitating the locating and mapping of a leak to a specific location with respect to a specific pipeline scheme.

According to an embodiment of the invention, the data communication channel comprises a data cable electrically connected on one side to the one or more sensors and on the other side to the processing unit.

According to an embodiment of the invention, the data communication channel comprises:
a. a wireless transmitter electrically connected to the output of the one or more moisture sensors configured to wirelessly transmit data regarding a leak detection from one or more moisture sensors; and
b. a wireless receiver electrically connected to an input port of the processing unit configured to receive said transmitted data from said transmitter and transfer said received data to the processing unit;

According to an embodiment of the invention, the system further comprises an indication unit configured to receive electrical notifications from said processing unit, said notifications indicating that a leak has been detected, and to issue a local alert indicating the same.

According to an embodiment of the invention, notifications are transmitted from the processing unit to the indication unit via wired communication.

According to an embodiment of the invention, notifications are transmitted from the processing unit to the indication unit via wireless communication.

According to an embodiment of the invention, the one or more moisture sensors comprise alert circuitry configured to issue an alert to the surroundings of the sensor upon detecting moisture above the predefined threshold.

In another aspect, the present invention relates to a system for detecting and locating leaks in a pipe, wherein: a) each of the one or more moisture sensors further comprises a unique identification tag that upon detecting moisture above the predefined threshold is transmitted to the processing unit along with the electrical leak alert signal; b) the processing unit further comprises a memory unit on which data relating each moisture sensor to its location is stored. The system characterized in that upon receiving a leak alert signal the processing unit recognizes, according to said identification tag sent therealong, the sensor that issued the leak alert signal and the location thereof, and sends said location of the sensor along with the electrical leak notification to relevant parties.

According to an embodiment of the invention, the system further comprises a capillary element in contact with each one or more moisture sensor configured to transmit moisture from a location along the pipe to a sensor.

According to an embodiment of the invention, the distribution element is a cylindrically shaped sheet that is suitable to surround at least part of a pipe's circumference.

According to an embodiment of the invention, the system further comprises an augmented reality system for applying three-dimensional (3D) scanning/mapping of infrastructures within an installation site, wherein said 3D scanning/mapping are combined in said augmented reality system to virtually present the exact location of said infrastructure at said site after said infrastructure have become concealed.

### BRIEF DESCRIPTION OF THE DRAWINGS

In the drawings:

FIG. 1 schematically illustrates a leak detection and location system, according to an embodiment of the invention;

FIG. 2 schematically illustrates scanning and mapping of pipe infrastructure within an installation site;

FIG. 3 schematically illustrates an example of the use of the system to deploy virtual image of mapped infrastructures installation over the location of real-world objects that currently conceal the infrastructures with an installation site, according to an embodiment of the invention;

FIG. 4 schematically illustrates a moisture sensor in form of a sensing cable, according to an embodiment of the invention;

FIG. 5 schematically illustrates a leak detection and location system, according to another embodiment of the invention;

FIG. 6 schematically illustrates a leaking pipe and a leak detection system, according to another embodiment of the invention;

FIG. 7 schematically illustrates a perspective section view of a pipe, circumferentially surrounded by a distribution element, according to an embodiment of the invention;

FIG. 8 schematically illustrates the distribution of a distribution element across the roof of a building, according to an embodiment of the invention;

FIGS. 9A and 9B schematically illustrate the distribution elements provided in the form of elongated strips of a predefined length, according to an embodiment of the invention; and

FIG. 10 schematically illustrates the distribution of a distribution element provided in the form of elongated strips across the roof of a building, according to an embodiment of the invention.

### DETAILED DESCRIPTION OF THE INVENTION

Reference will now be made to an embodiment of the present invention, examples of which are illustrated in the accompanying figures for purposes of illustration only. One skilled in the art will readily recognize from the following description that alternative embodiments of the structures and methods illustrated herein may be employed, mutatis mutandis, without departing from the principles of the claimed invention.

According to an embodiment of the invention, the system described herein, combines three main elements: a first element is an Augmented Reality (AR) scanning means for providing data suitable for deploying virtual image over the location of real-world objects of mapped infrastructure installation within an installation site, a second element is one or more moisture sensors and third element is a control unit.

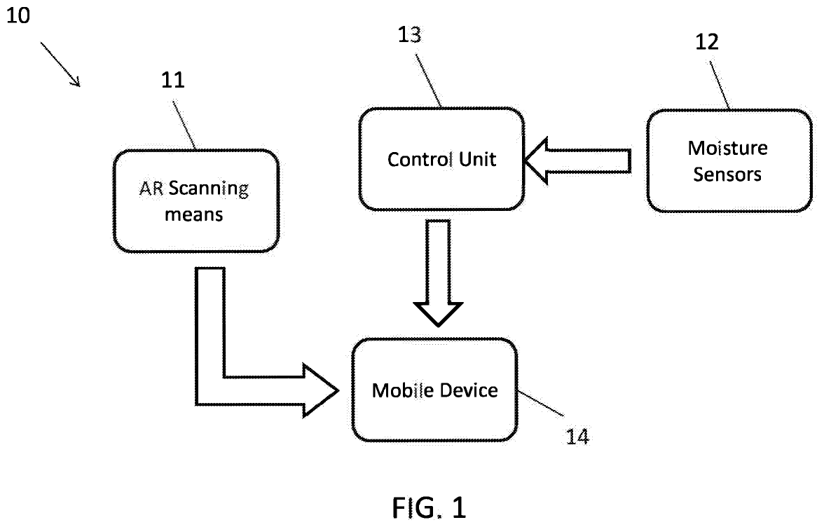

FIG. 1 schematically illustrates, a block diagram form, of leak detection and locating system 10, according to an embodiment of the invention. System 10 comprises an AR scanning means 11 (e.g., a three dimensional (3D) AR scanning system), one or more moisture sensors 12 configured to generate an electrical leak alert signals upon detecting moisture above a predefined threshold, and a control unit 13.

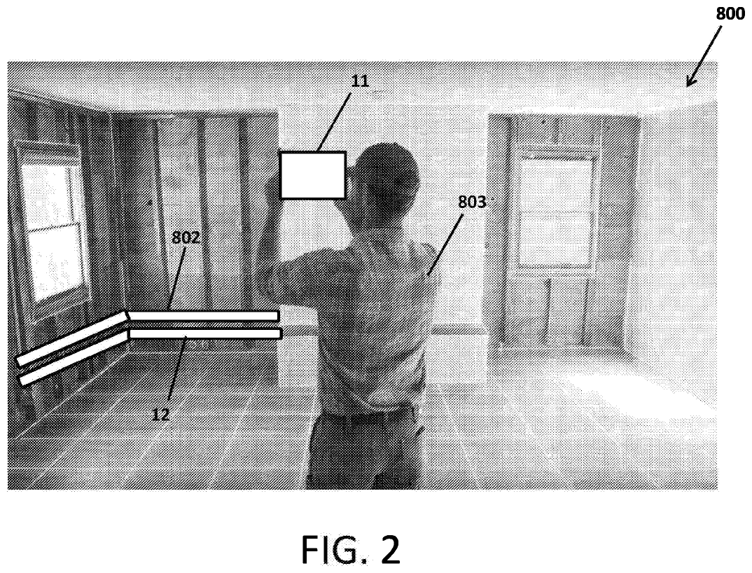

AR scanning means 11 suitable to scan and map an uncovered infrastructure installation within an installation site. For example, FIG. 2 schematically illustrates a user 803 that uses AR scanning means 11 to scan and map installed infrastructure within an installation site 800, such as pipes 802 and moisture sensors 12.

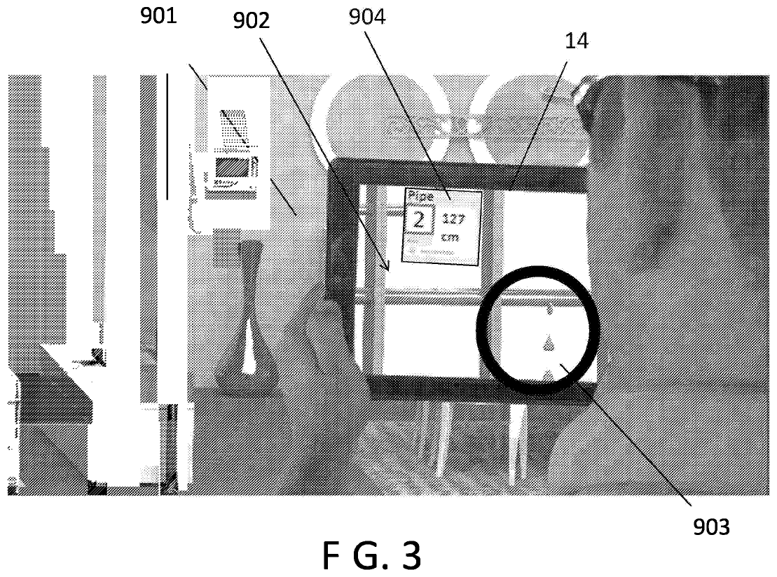

The infrastructure installation may comprise at least one or more pipes (e.g., such as pipes 802 in FIG. 2) and one or more moisture sensors 12 that are adapted to be installed in conjunction with the pipes as part of the infrastructure installation. Although the infrastructure installation may further comprise other elements such as electrical wiring, gas conduits, etc. the present invention is focused on the pipes, in particular on the one directed to transfer water (e.g., domestic pipelines of an apartment). In this context, AR scanning means 11 enables to present the infrastructure pipelines at an AR form after the infrastructure within the installation site has been covered (e.g., by one or more covering layers). A mobile device 14 (e.g., a smartphone or other suitable device) can be used to deploy virtual image of the mapped infrastructure installation over the location of real-world objects that currently conceal the infrastructure with the installation site. For example, the pipes can be installed within a wall or floor of an apartment that is currently covered by tiles or other sort of wall or floor covering layer, such as hard plaster, paint, etc. FIG. 3 schematically illustrates an example of the use of system 10 to deploy virtual image 902 of a mapped infrastructure installation over the location of a wall 901 (i.e., a real-world object) that currently conceal the actual infrastructure (i.e., the actual infrastructure that is virtually presented on mobile device 14 by virtual image 902).

Control unit 13 configured to receive leak alert signals from moisture sensor 12, to process the received signals in order to determine a leakage location at the infrastructure, and to enable visual indication of the leakage location, e.g., as indicated in FIG. 3 by numerals 903 and 904 via mobile device 14, by superimposition of virtual images of at least part of the mapped infrastructure installation over the location of real-world objects at the installation site, e.g., which can be an apartment, a condo, an office, etc. For example, in FIG. 3, two forms of visual indication 903, 904 are shown, wherein visual indication 903 shows a virtual presentation of a leakage, while visual indication 904 provides data regarding the exact leakage location.

According to an embodiment of the invention, moister sensor 12 is provided in the form of a sensing cable, e.g., which may comprise four wires, two sensing wires and two signaling wires. The sensing cable is attached to the pipes (e.g., it can be deployed in parallel to the pipeline) and whenever there is a leak, an electric circuit is closed and a signal is transmitted to control unit 13.

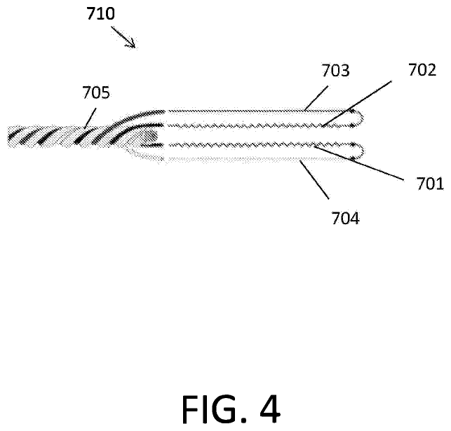

FIG. 4 schematically illustrates a moisture sensor in form of a sensing cable 710, according to an embodiment of the invention. Sensing cable 710 comprises two metal sensing wires 701, 702, a continuity wire 703 and a signal wire 704, protected by a fiber material 705. The cable is situated in adjacency to the pipe, and so when there is a leak, water is soaked through the fiber material 705. As water is conductive, when it comes in contact with the wires 701, 702, it acts as a switch and connects the two metal wires together, and creates a short circuit between the two sensing wires 701 and 702. A signal is then returned to the processing unit and the processing unit signals an alarm. The cable is a resistive based and so the cable has specific ohms per foot, which allows control unit 13 to determine the footage reading to locate the leak (e.g., the distance from a predetermined reference point).

Controller unit 13 is connected to all the moisture sensors (e.g., to all sensing cable 710) and measures the resistance per distance of the controller from each sensor. According to an embodiment of the invention, controller unit 13 may check and measure the system several times per day (e.g., according to a predetermined number of times which can be set by an authorized user), and the results of the taken measures are compared. The comparison enables controller unit 13 to analyze a leak signal and to determine whether it is a real leak or a false alarm. In case of real leak, control unit 13 may send a notification (e.g., a notification message to a mobile device of the authorized user, such as by SMS, email, via dedicated application, or via any other available way) to report about a leakage detection. In case there is a real leak, control unit 13 sends to the user a notification with the location of the detected leak. Upon receiving such a notification, mobile device 14 can be used as described with respect to FIG. 3 hereinabove.

Once receiving such a notification, the exact location of the leak can be presented on the screen of mobile device 14 or via any other device suitable to provide visual indication using AR as described hereinabove with respect to FIG. 3, thereby facilitating detection and repairmen of the leak, e.g., by a professional person.

In an embodiment of the system of the invention, after installing all the required infrastructures in an installation site, for example the water pipes and the electricity cables, in walls, floor or ceilings of a specific apartment or a specific room, AR scanning means 11 is used to scan and map the installation site before the infrastructures become concealed with suitable covering materials or layers. The scanned images of the infrastructure are then combined in an augmented reality system and each pipe (or section of a pipe) is given an identification number to facilitate a future detection, to be used after the installed infrastructures have been covered, to virtually present the exact location of the installed infrastructure over a covered wall, floor or ceiling. This enables to easily locate the exact location of concealed infrastructures, as well as to easily detect the exact location of a leak in real-time or to locate the exact deployment of electric cables within walls/floor/ceiling. Moreover, the scanned images can be used, e.g., by a remote user, to verify the correctness of the installation.

In an embodiment of the invention, the system may distinguish between true or false alarms, i.e., whether a generated alert signal reflects a leakage that occur due to a faulty pipe or as a result of temporary event. The system may determine that a generated alert signal is a false alarm, e.g., when the generated alert signal occurred due to a temporary moisture event that caused by a floor washing action. In such example of floor washing, the water that caused the moisture event will shortly fade away, thus the system may generate a leakage notification only for specific patterns or behavior associated with the generated alert signals, to ensure that the generated alert signal is not caused by a temporary leakage event (e.g., the patterns or behavior may consider alerts timing or period, origin or location of simulations alerts, etc.). According to an embodiment of the invention, the system may involve machine learning capabilities in order to distinguish between true and false alarms.

For example, AR scanning means 11 or other suitable augmented reality system may comprise a tablet (e.g., an iPad by Apple Inc.) to which a three-dimensional (3D) AR scanner is attached, such as the Structure Sensor by Occipital, Inc. or any other device suitable to provide a scale-accurate 3D model of an installation site such as interior spaces of an apartment or a room, 3D scanning of objects, or 3D maps of interior spaces, and combine them with augmented reality. As described hereinabove, FIG. 2 schematically illustrates an example of 3D mapping of the infrastructure within an installation site 800. In this illustrated example, installation site 800 is a room within an apartment, and user 803 uses AR scanning means 11 (e.g., which can be a 3D AR scanner attached to an iPad) to map an unconcealed infrastructure 802. In this figure, infrastructure 802 is a water pipe installed on some of the room's walls and shown prior to their covering. After the scanning the installed infrastructure usually covered with one or more layers of hard plaster together with at least part of the wall's surface.

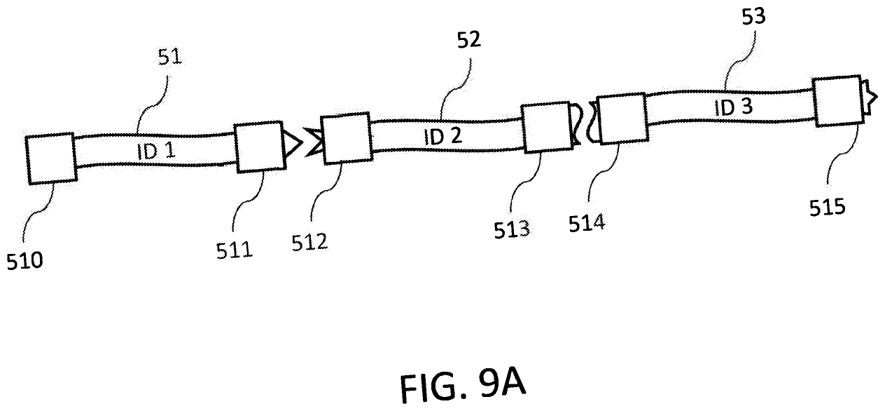

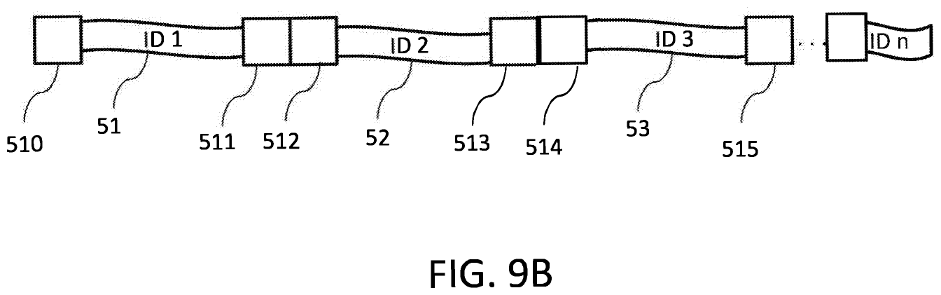

FIG. 9 schematically shows an example of the use of the system of the invention with the augmented reality system where a user scans the concealed installation site with a tablet 902, where the system of the invention detects and presents the leak location 903 and issues a notification 904 to the user which indicates the location of the leak and the pipe that was leaking.

According to another embodiment of the invention, the system of the present invention comprises a plurality of moisture sensors (such as RFM2100 Wireless Flexible Moisture Sensor available from RFMicron, Inc. for a wireless implementation or other type of moisture sensors suitable for non-wireless implementation) distributed among a distribution element, e.g., at a fixed distance from one another. The distribution element is configured to be situated adjacent to a pipe in order to detect leaks therein. Upon detecting moisture above a predefined threshold in its vicinity, a moisture sensor generates a leak alert signal.

In this embodiment, the system further comprises a processing unit for receiving leak alert signals from the moisture sensors, locating the sensor and the leak, and for issuing notifications regarding detected leaks and their locations. In order to locate a leak, each moisture sensor is assigned a unique identifier that is sent to the processing unit indicating the specific sensor at the location of which a leak is detected. Leak alert signals can be transmitted from a moisture sensor to the processing unit either wirelessly or in a wired manner. During or after the installation of the system, the moisture sensors are mapped according to their physical location (or coverage range) with respect to the pipeline scheme on which they are installed. For example, the moisture sensors can be mapped on a digital representation of a pipeline scheme.

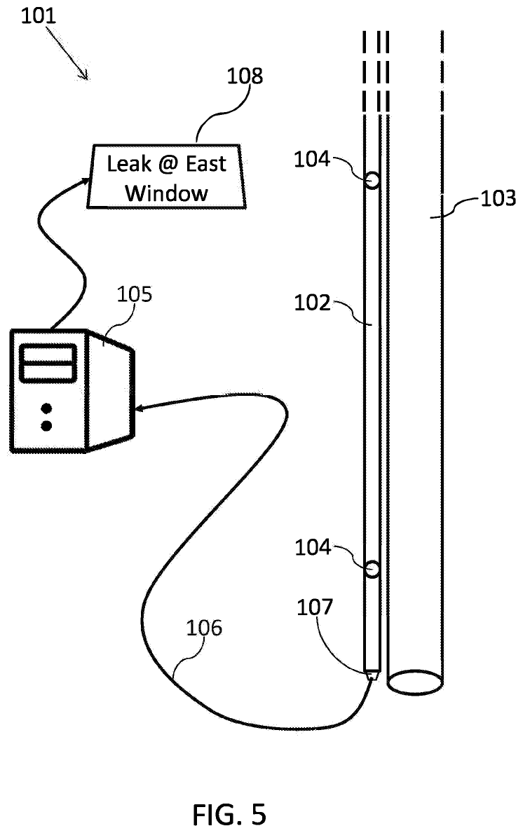

FIG. 5 schematically illustrates a leak detection and location system 101 according to another embodiment of the invention. System 101 comprises a distribution element 102 situated in adjacency to a pipe 103. Moisture sensors 104 are distributed among distribution element 102. In this embodiment, an electrical communication wire 106 (i.e., a data cable) is connected between a processing unit (PU) 105 and distribution element 102. Wire 106 is configured to transmit data from each of moisture sensors 104 to processing unit 105 so as to receive leak alerts and other relevant data therefrom.

According to an embodiment of the invention, each moisture sensor 104 is electrically connected to an output port 107, to which a data cable (e.g. wire 106) can be connected so as to transmit data from the sensors 104 to a processing unit (e.g. PU 105). According to another embodiment of the invention, each moisture sensor 104 is electrically connected to a general data bus (now shown) that is part of distribution element 102. The general data bus receives data from each of the moisture sensors 104, and outputs the data from all of the sensors to port 107.

According to yet another embodiment of the invention, port 107 is electrically connected to a wireless transmitter (not shown) and data from moisture sensors 104 is wirelessly transmitted by the transmitter to a wireless receiver (not shown) that is electrically connected to processing unit 105.

According to the received data from moisture sensors 104 the processing unit 105 may conclude that a leak has occurred in the vicinity of one or more of the sensors, e.g., by using suitable software running on processing unit 105. Upon reaching the above conclusion, a leak indication is issued and sent from processing unit 105 to a relevant party. The indication comprises an alert informing relevant parties that a leak has been detected. The indication can be sent (either wirelessly or in a wired manner) to an indication unit 108, or, according to another embodiment of the invention, may be wirelessly sent to a remote receiver (e.g., a remote server) at the relevant party side.

According to an embodiment of the invention, a remote server may store information regarding the mapping of moisture sensors installed with respect to each specific pipeline scheme of a specific property, such as of a specific apartment in a building. In such embodiment, the relevant party may include a domestic pipeline scheme of a specific apartment that also shows the mapping of the moisture sensors 104 on top of the pipeline scheme. This enables to provide the accurate location of a leakage in the apartment (e.g., by showing visual indication on top of the pipeline scheme). In some embodiments, one may access a digital representation of each specific pipeline scheme and view leakage alerts by several ways, for example, by scanning a QR code located within an apartment associated with the specific pipeline scheme, by using a dedicated smartphone application, by providing relevant access code or credentials via a dedicated website, etc.

According to an embodiment of the invention each moisture sensor 104 comprises alert circuitry suitable for issuing an alert to the surroundings of the sensor. The alert may be a sound alert (e.g. a buzzing/humming/beeping sound), a visual alert (e.g. a lighten LED that can be seen through a wall with IR imaging equipment), a physical alert (e.g. a vibration) or any other type of alert known in the art that can indicate that moisture has been detected by the moisture sensor.

According to an embodiment of the invention system 101 is configured to detect the location of a leak along a pipe to which a distribution element 102 is coupled. Accordingly, in this embodiment each moisture sensor 104 is assigned a unique identification tag that is transmitted to the processing unit 106 along with detection data. Processing unit 106 further comprises software capable of recognizing a sensor from which a leak alert signal was issued, and notify the relevant parties the location of the leak. In this embodiment the processing unit 106 further comprises position data stored on a local memory unit (not shown), the data relating each moisture sensor to the location thereof among the pipeline or structure throughout which the sensors 104 and distribution element 102 are distributed. When receiving a moisture alert signal from a sensor, the location thereof is recognized by comparing the unique identification tag received with the alert signal, to the position data, and the location of the moisture sensor that issued the alert signal (to which the unique identification tag belongs) is sent to the relevant parties along with the leak indication.

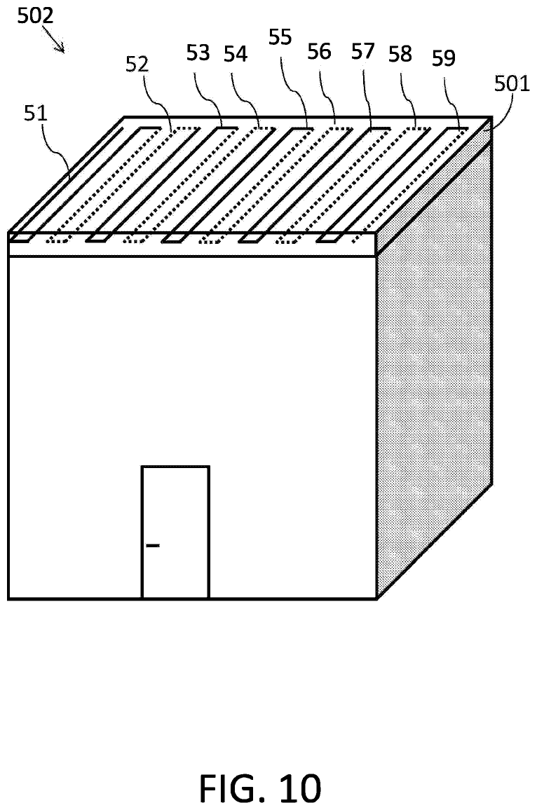

Referring now to FIGS. 9A, 9B and 10, in order to support the abovementioned feature of locating a leak according to the identification tag received along with a leak alert, according to an embodiment of the invention, the distribution elements can be provided in the form of elongated strips of a predefined length as indicated in details by numerals 51-53 in FIGS. 9A and 9B, and as also indicted by numerals 51-59 in FIG. 10. For example, the length of each elongated strip can be 50 cm, 1 meter or any other length that may be sufficient for laying out and connecting strips along a pipeline or throughout a building. In some embodiments, each strip can be placed adjacent to a pipe (or to any other location where leak detection is required, e.g., on a roof 501 of a building 502 as shown in FIG. 10) and uniquely connected on either side to a predefined other strip by a unique connector, thereby facilitating the locating and mapping of a leak to a specific location within a building to a specific pipeline scheme.

As shown in FIGS. 9A and 9B, each elongated strip 51, 52 and 53 has a unique ID (herein ID1-ID3, respectively) and a unique connector at each side as indicated by numerals 510-515. The unique connectors ensure that elongated strips will be connected only in a specific order according to their IDs, thereby enabling to facilitate their mapping on a corresponding pipeline scheme (e.g., a digital form of a pipeline scheme), rather than just randomly placing and connecting the elongated strips. In this embodiment, elongated strip 51 (associated with ID 1) includes unique connectors 510 and 511, elongated strip 52 (associated with ID 2) includes unique connectors 512 and 513, and elongated strip 53 (associated with ID 3) includes unique connectors 514 and 515. FIG. 9A shows elongated strips 51-53 prior to their connection and FIG. 96 shows them after being connected.

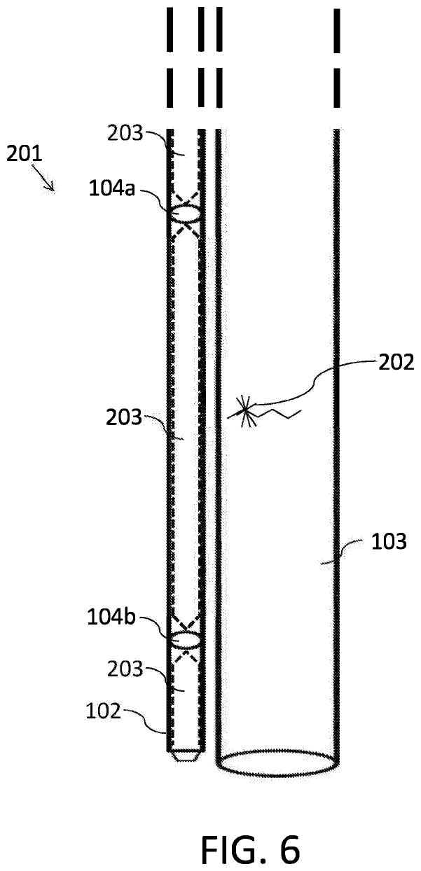

According to an embodiment of the invention, the system further comprises capillary elements provided in between moisture sensors for transmitting moisture from one part of the distribution element to another part. Specifically, the capillary elements allow detecting leaks that occur at locations along a pipe where there isn't a moisture sensor. FIG. 6 schematically illustrates a leaking pipe 103 and a leak detection system 201 according to this embodiment. Leak 202 is located between moisture sensors 104a and 104b. In the sensors would not be able to detect such a leak. For this matter capillary element 203 is provided among distribution element 102 for transmitting moisture from leak 202 to one of the sensors 104a or 104b. The capillary element 203 consists of a material with high capillarity such as paper, plaster, wool, polyester, other wicking materials, etc.

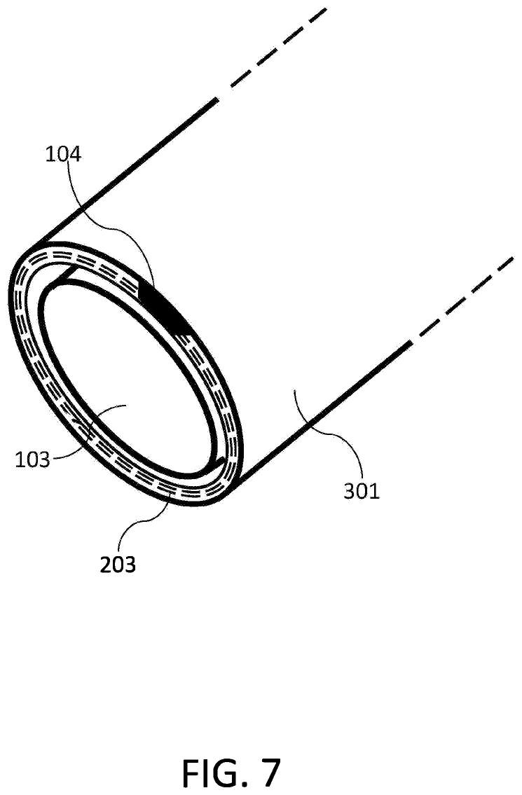

The distribution element 102 illustrated in FIGS. 5 and 6 is shown as an elongated flat sheet suitable to be connected to a pipe 103's exterior. According to an embodiment of the invention, the distribution element is a cylindrically shaped sleeve that is suitable to surround at least a portion of a pipe's circumference. FIG. 7 schematically illustrates a perspective section view of a pipe 103, completely circumferentially surrounded by distribution element 301 according to this embodiment. Capillary element 203 is provided throughout the length of distributing element 301 and circumferentially around pipe 103. This embodiment is sufficient for detecting a leak at any position along a pipe's length and circumference due to the wide coverage the capillary element provides of moisture transmission from a leak to any of the moisture sensors 104.

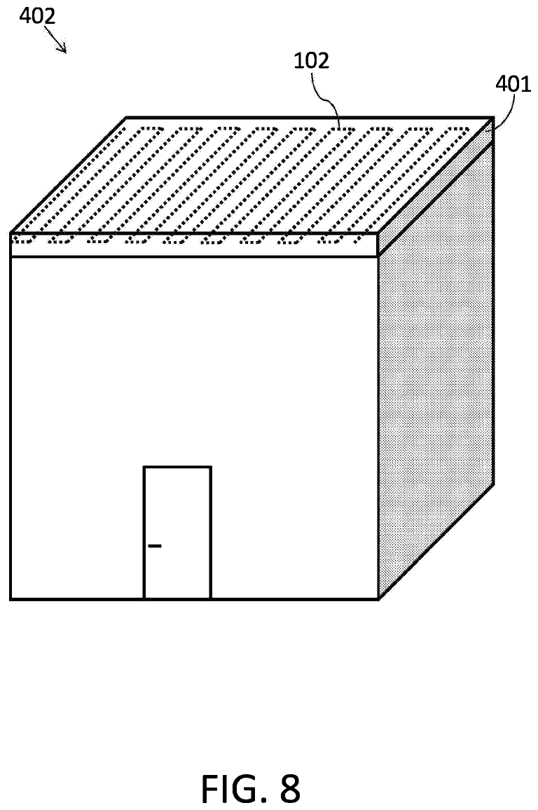

According to an embodiment of the invention, a leak detection and location system 101 can be utilized in order to detect a leak that occurs in the structure of a building that is not related to a pipe. In this embodiment a system 101 is provided within a wall or the roof of a building, and alerts when a leak is detected. The system may be distributed in any manner, shape and location that is sufficient to detect a leak in various locations that are prone to leak (e.g. throughout a wall's perimeter, across a complete roof, etc.). FIG. 8 schematically illustrates the distribution of a distribution element 102 across the roof 401 of a building 402.

Although embodiments of the invention have been described by way of illustration, it will be understood that the invention may be carried out with many variations, modifications, and adaptations, without exceeding the scope of the claims.

1. Leaks detection and locating system, comprising:
a) an Augmented Reality (AR) scanning means for providing data suitable for deploying virtual image over the location of real-world objects of mapped infrastructure installation in an installation site;
b) at least one moisture sensor adapted to be installed in conjunction with at least one pipe as part of said infrastructure installation, wherein said at least one sensor configured to generate an electrical leak alert signal upon detecting moisture above a predefined threshold; and
c) a control unit configured to receive leak alert signals from said at least one moisture sensor, to process said received signals in order to determine a leakage location at said infrastructure, and to enable visual indication of the leakage location by superimposition of virtual images of at least part of said mapped infrastructure installation over the location of real-world objects.

2. The system according to claim 1, wherein the control unit is configured to determine whether a received leak alert signal is a true or false alarm.

3. The system according to claim 1, wherein the moisture sensor s a sensing cable adapted to be installed in parallel to the at least one pipe.

4. The system according to claim 3, wherein the sensing cable comprises at least two metal sensing wires, a continuity wire and a signal wire, protected by a fiber material, thus an electrical leak alert signal is generated by said sensing cable when water is soaked through said fiber material and connects said two metal sensing wires together, creating a short circuit between said two sensing wires, wherein the short circuit location defines the leakage location.

5. The system according to claim 1, wherein the control unit determines the leakage location by calculating the distance of the short circuit location from a predetermined reference point.

6. The system according to claim 5, wherein the reference point is located at one end of the sensing cable through which the electrical leak alert signal is provided to the control unit.

7. The system according to claim 1, wherein the scanning means comprises a three-dimensional (3D) AR scanner.

8. The system according to claim 1, wherein the visual indication of the leakage location is provided via a mobile device suitable to render virtual images over the location of real-world objects.

9. A method for detecting leaks in a pipe, comprising:
a) Providing, by an Augmented Reality (AR) scanning means, data suitable for deploying virtual image over the location of real-world objects of mapped infrastructure installation in an installation site, wherein the infrastructure installation comprises at least one pipe and at least one corresponding moisture sensor adapted to be installed in conjunction with said at least one pipe, wherein said at least one moisture sensor is configured to generate an electrical leak alert signal upon detecting moisture above a predefined threshold;
b) Upon receiving, by a control unit, an electrical leak alert signal generated by a moisture sensor, processing said received alert signal, determining whether said received alert signal is a true or false alarm and obtaining a leakage location at said infrastructure in accordance with the origin from which the electrical leak alert signal has been generated; and
c) For a true alarm, generating a leakage notification that enables the visual indication of the leakage location by superimposition of virtual images of at least part of said mapped infrastructure installation over the location of real-world objects.

10. The method according to claim 9, wherein the infrastructure installation is being scanned at the installation site before being concealed by one or more covering layers, thereby enabling to provide visual indication of the mapped infrastructure installation by superimposition of virtual images of said mapped infrastructure installation or at least part of said mapped infrastructure installation over the location of real-world objects that conceals said infrastructure, such as the one or more covering layers.

11. The method according to claim 9, wherein the visual indication comprises combining of images of the mapped infrastructure installation and data relative to the leakage location.

12. The method according to claim 11, wherein the visual indication further comprises one or more real-world objects that at least partially cover the mapped infrastructure.

13. The method according to claim 9, wherein the moister sensor is a sensing cable that comprises at least two metal sensing wires, a continuity wire and a signal wire, protected by a fiber material, thus an electrical leak alert signal is generated by said sensing cable when water is soaked through said fiber material and connects said two metal sensing wires together, creating a short circuit between said two sensing wires, wherein the short circuit location defines the leakage location.

14. The method according to claim 9, wherein the leakage location is obtained by calculating the distance of the short circuit location from a predetermined reference point.

15. A system for detecting leaks in a pipe, comprising:
a. one or more moisture sensors adapted to be situated adjacent to said pipe, wherein said one or more moisture sensors configured to generate an electrical leak alert signal upon detecting moisture above a predefined threshold; and
b. a processing unit configured to receive leak alert signals from said one or more moisture sensors and issue electrical leak notifications regarding a received signal to relevant parties, said notifications indicating that a leak has been detected by a moisture sensor.

16. The system according to claim 15, further comprising an augmented reality system configured to apply three-dimensional (3D) Augmented reality (AR) scanning of infrastructures within an installation site, wherein said 3D AR scanning are combined in said augmented reality system to virtually present the exact location of said infrastructure after said infrastructure have become concealed.

17. The system according to claim 16, wherein the infrastructures are water pipes and electricity cables.

18. The system according to claim 15, further comprising a data communication channel between the one or more moisture sensors and the processing unit for transferring data therebetween.

19. The system according to claim 15, further comprising a distribution element among which moisture sensors are distributed, wherein the distribution element is situated in adjacency to a pipe such that each sensor is capable of detecting moisture in the pipe's exterior.

20. The system according to claim 19, wherein the distribution element is in the form of elongated strips of a predefined length.

21. The system according to claim 20, wherein each strip can be placed adjacent to a pipe or to any other location where leak detection is required and uniquely connected on either side to a predefined other strip by a unique connector, thereby facilitating the locating and mapping of a leak to a specific location with respect to a specific pipeline scheme.

22. The system according to claim 18, wherein the data communication channel comprises a data cable electrically connected on one side to the one or more sensors and on the other side to the processing unit.

23. The system according to claim 18, wherein the data communication channel comprises:
a. a wireless transmitter electrically connected to the output of the one or more moisture sensors configured to wirelessly transmit data regarding a leak detection from one or more moisture sensors; and
b. a wireless receiver electrically connected to an input port of the processing unit configured to receive said transmitted data from said transmitter and transfer said received data to the processing unit;

24. The system according to claim 15, further comprising an indication unit configured to receive electrical notifications from said processing unit, said notifications indicating that a leak has been detected, and to issue an alert indicating the same.

25. The system according to claim 24, wherein notifications are transmitted from the processing unit to the indication unit via wired or wireless communication.

26. The system according to claim 15, wherein the one or more moisture sensors comprise alert circuitry configured to issue an alert to the surroundings of the sensor upon detecting moisture above the predefined threshold.

27. The system according to claim 15, wherein:
a. each of the one or more moisture sensors further comprises a unique identification tag that upon detecting moisture above the predefined threshold is transmitted to the processing unit along with the electrical leak alert signal; and
b. the processing unit further comprises a memory unit on which data relating each moisture sensor to its location is stored;
characterized in that upon receiving a leak alert signal the processing unit recognizes, according to said identification tag sent therealong, the sensor that issued the leak alert signal and the location thereof, and sends said location of the sensor along with the electrical leak notification to relevant parties.

28. The system according to claim 15, further comprising a capillary element in contact with each one or more moisture sensor configured to transmit moisture from a location along the pipe to a sensor.

29. A system according to claim 16, wherein the distribution element is a cylindrically shaped sheet that is suitable to surround at least part of a pipe's circumference.
